(19) United States
(12) Patent Application Publication
(10) Pub. No.: US 2014/0165729 A1
(43) Pub. Date: Jun. 19, 2014

(54) ACOUSTIC EMISSION DIAGNOSIS DEVICE FOR GAS VESSEL USING PROBABILISTIC NEURAL NETWORK AND METHOD OF DIAGNOSING DEFECT OF CYLINDER USING THE SAME

(71) Applicant: Korea Institute of Machinery & Materials, Daejeon-si (KR)

(72) Inventors: Hyun Sup JI, Gyeongsangnam-do (KR); Jong O Lee, Gyeongsangbuk-do (KR); No Hoe JU, Gyeongsangnam-do (KR)

(73) Assignee: Korea Institute of Machinery & Materials, Daejeon-si (KR)

(21) Appl. No.: 13/728,410

(22) Filed: Dec. 27, 2012

(30) Foreign Application Priority Data
Dec. 13, 2012 (KR) 10-2012-0144995

(51) Int. Cl. G01N 29/14

(52) U.S. Cl. CPC G01N 29/14
USPC 73/587

(57) ABSTRACT

An acoustic emission diagnosis device is provided for a gas vessel using a probabilistic neural network, and a method of diagnosing a defect of the gas vessel using the same, in which acoustic emission signal sensors are attached to multiple portions of the gas vessel. Acoustic emission signals are detected when filling the inside of the gas vessel with gas, when holding the pressure after filling, and when decreasing the pressure. Features in which the detected acoustic emission signals are varied are extracted, and a damaged degree of the gas vessel is determined using the probabilistic neural network that has been trained through a classification learning algorithm for the extracted features.

### CROSS-REFERENCE TO RELATED APPLICATIONS

This application claims foreign priority benefits under U.S.C. §119(a)-(d) to Korean Patent Application No. 10-2012-0144995 filed on Dec. 13, 2012, in the Korean Intellectual Property Office, the disclosure of which is incorporated herein by reference in its entirety.

### BACKGROUND

1. Technical Field

The present disclosure relates to an acoustic emission diagnosis device for a gas vessel using a probabilistic neural network and a method of diagnosing a defect of the gas vessel using the same, and more particularly, to an acoustic emission diagnosis device for a gas vessel using a probabilistic neural network and a method of diagnosing a defect of the gas vessel using the same, in which acoustic emission signal sensors are attached to a plurality of portions of the gas vessel, acoustic emission signals are detected when filling the inside of the gas vessel with gas, when holding the pressure after filling, and when decreasing the pressure, features in which the detected acoustic emission signals are varied are extracted, and a damaged degree of the gas vessel is determined using the probabilistic neural network that has been trained through a classification learning algorithm for the extracted features.

2. Description of the Related Art

A gas vessel is configured to store therein gas of a high pressure and supply to the outside when necessary, and is classified to four types depending on a material and a configuration of the gas vessel.

Among the four types, a type II gas vessel in which a composite material is wound at a metal liner made of, for example, steel or aluminum is lighter in weight than that of a vessel made of a steel material, and thus the type II gas vessel is used as gas vessels for more than ten million vehicles all over the world.

A conventional type II gas vessel 1 includes a metal liner 2 and a composite material 3, as illustrated in FIG. 1.

The metal liner 2 does not have a welded portion to airtightly maintain, and the composite material 3 is provided to hold a pressure.

However, since a gas vehicle has been used without replacing the gas vessel for long periods of time after the gas vehicle is manufactured, the gas vessel may burst due to the decrepitude thereof, and such a burst causes the blast. Accordingly, the gas vessel needs to be diagnosed.

Such a gas vessel is inspected and diagnosed with the naked eye. However, since the gas vessel is provided within the vehicle, a minute inspection may not be performed for all the portions within the vessel through such an inspection with the naked eye.

Korean Publication No. 10-2010-0041696 describes a technology of detecting a sign of damage in advance using relation between a pressure and a hit ratio of the acoustic emission signal obtained by a bursting test.

Disadvantageously, in order to detect the damage of the gas vessel in advance using only the hit ratio, a burst pressure needs to be previously known in the bursting test. Especially, with regard to the damage due to the fatigue, a pressure applied to the gas vessel is in a range of a working pressure that is considerably less than the burst pressure. Since a burst mechanism thereof is different from that in the bursting test, it is difficult to accurately determine the damage due to the fatigue.

Korean Patent No. 10-1033260 describes “an acoustic emission diagnosis device for a gas vessel and a method of diagnosing a defect of the gas vessel using the same,” in which acoustic emission signal sensors are attached to a plurality of portions of the gas vessel, and at least two or more acoustic emission parameters among acoustic emission parameters such as amplitude, rise time, count, and duration are combined to determine a damaged degree of the gas vessel.

However, the conventional technologies described above have the following problems.

Specifically, when two or more parameters are combined among a plurality of acoustic emission parameters, it is difficult for a lay person to combine the two or more parameters. When the damage of the gas vessel is determined using the wrong combination, there is concern about misdiagnosis.

### SUMMARY

An aspect of the present disclosure provides an acoustic emission diagnosis device for a gas vessel using a probabilistic neural network and a method of diagnosing a defect of the gas vessel using the same, in which acoustic emission signal sensors are attached to a plurality of portions of the gas vessel to detect acoustic emission signals, and features are extracted from the detected acoustic emission signals, so that a damaged degree of the gas vessel can be determined using the probabilistic neural network that has been trained through a classification learning algorithm for the extracted features.

An aspect of the present disclosure also provides an acoustic emission diagnosis device for a gas vessel using a probabilistic neural network and a method of diagnosing a defect of the gas vessel using the same, in which the features of the acoustic emission signals are analyzed when filling the inside of the gas vessel with gas, when holding the pressure after filling, and when decreasing the pressure by evacuating the gas, so that the defect of the gas vessel can be diagnosed with more accuracy.

According to an aspect of the present disclosure, there is provided an acoustic emission diagnosis device for a gas vessel using a probabilistic neural network. The device diagnoses a defect of the gas vessel including a metal liner and a composite material wound at a part of an outer surface of the metal liner to reinforce the metal liner. The device includes a second acoustic emission signal sensor that is attached to a center of an outer surface of the composite material to detect an acoustic emission signal; a first acoustic emission signal sensor that is attached to a bottom part of the outer surface of the metal liner at which the composite material is not provided to detect an acoustic emission signal; a signal processing unit that represents the acoustic emission signals detected by the first acoustic emission signal sensor and the second acoustic emission signal sensor as two or more acoustic emission parameters among the number of hits, amplitude, energy, rise time, count, duration, strength, a signal level, and RMS (Root Mean Square); and a diagnosis unit that extracts a feature by analyzing the acoustic emission parameters and determines a damaged degree of the gas vessel using the probabilistic neural network that has been trained through a classification learning algorithm for the acoustic emission parameters.

The first acoustic emission signal sensor and the second acoustic emission signal sensor may consecutively detect the acoustic emission signals during a period of time to increase an internal pressure of the metal liner to a set pressure, during the set pressure, and during a period of time to decrease the internal pressure to a level less than the set pressure.

The signal processing unit may convert the acoustic emission signals detected by the first acoustic emission signal sensor and the second acoustic emission signal sensor into the acoustic emission parameters, and simultaneously represent a change in the number of the acoustic emission signals as the converted acoustic emission parameters.

The set pressure may correspond to a working pressure of the gas vessel, and the first acoustic emission signal sensor and the second acoustic emission signal sensor may detect the acoustic emission signals during a predetermined set time.

According to another aspect of the present disclosure, there is provided a method of diagnosing a defect of a gas vessel by an acoustic emission diagnosis device for the gas vessel using a probabilistic neural network. The gas vessel includes a metal liner and a composite material wound at a part of an outer surface of the metal liner to reinforce the metal liner. The method includes attaching a second acoustic emission signal sensor to a center of an outer surface of the composite material to detect an acoustic emission signal and attaching a first acoustic emission signal sensor to a bottom part of the outer surface of the metal liner at which the composite material is not provided to detect an acoustic emission signal; detecting the acoustic emission signals by sequentially increasing, holding, and decreasing an internal pressure of the metal liner; representing the acoustic emission signals as two or more acoustic emission parameters among the number of hits, amplitude, energy, rise time, count, duration, strength, a signal level, and RMS (Root Mean Square) by a signal processing unit serving as a component of the acoustic emission diagnosis device for the gas vessel; extracting a feature from the acoustic emission parameters; and diagnosing the defect of the gas vessel using the probabilistic neural network that has been trained through a classification learning algorithm for the acoustic emission parameters.

The detecting the acoustic emission signals may include a first detecting process of detecting during a period of time to reach a set pressure after the internal pressure of the metal liner starts to increase; a second detecting process of detecting during a set time after reaching the set pressure; and a third detecting process of detecting during a period of time to reduce the internal pressure of the metal liner after the set time elapses.

In the representing the acoustic emission signals, the acoustic emission signals detected by the first acoustic emission signal sensor and the second acoustic emission signal sensor may be converted into the acoustic emission parameters, and a change in the number of the acoustic emission signals may be simultaneously represented as the converted acoustic emission parameters.

In the detecting the acoustic emission signals, the set pressure may correspond to a working pressure of the gas vessel, and the set time may be set to be ten minutes.

The first acoustic emission signal sensor and the second acoustic emission signal sensor may consecutively operate during the first detecting process, the second detecting process, and the third detecting process.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an actual photograph illustrating a crack of a type II gas vessel;

FIG. 2 is a perspective view illustrating a configuration of an acoustic emission diagnosis device for a gas vessel using a probabilistic neural network according to an exemplary embodiment of the present disclosure;

FIG. 3 is a flowchart illustrating a method of diagnosing a defect of the gas vessel by the acoustic emission diagnosis device for the gas vessel using the probabilistic neural network according to the exemplary embodiment of the present disclosure;

FIG. 4 is a flowchart illustrating detailed processes of a detecting step as one step of the method of diagnosing the defect of the gas vessel by the acoustic emission diagnosis device for the gas vessel using the probabilistic neural network according to the exemplary embodiment of the present disclosure;

FIG. 5 is a graph illustrating zones for detecting acoustic emission signals in a detecting step as one step of the method of diagnosing the defect of the gas vessel by the acoustic emission diagnosis device for the gas vessel using the probabilistic neural network according to the exemplary embodiment of the present disclosure;

FIG. 6 is a table illustrating features to be extracted in an extracting step as one step of the method of diagnosing the defect of the gas vessel by the acoustic emission diagnosis device for the gas vessel using the probabilistic neural network according to the exemplary embodiment of the present disclosure;

FIG. 7 is an example table of a diagnosis grade to be used in a diagnosing step as one step of the method of diagnosing the defect of the gas vessel by the acoustic emission diagnosis device for the gas vessel using the probabilistic neural network according to the exemplary embodiment of the present disclosure;

FIG. 8 is a graph illustrating mean rise time during a first detecting process in the detecting step as one step of the method of diagnosing the defect of the gas vessel by the acoustic emission diagnosis device for the gas vessel using the probabilistic neural network according to the exemplary embodiment of the present disclosure;

FIG. 9 is a graph illustrating mean rise time during a second detecting process in the detecting step as one step of the method of diagnosing the defect of the gas vessel by the acoustic emission diagnosis device for the gas vessel using the probabilistic neural network according to the exemplary embodiment of the present disclosure;

FIG. 10 is a graph illustrating mean rise time during a third detecting process in the detecting step as one step of the method of diagnosing the defect of the gas vessel by the acoustic emission diagnosis device for the gas vessel using the probabilistic neural network according to the exemplary embodiment of the present disclosure;

FIG. 11 is a graph illustrating the number of hits of acoustic emission signals having amplitude of 50 dB or more during the first detecting process in the method of diagnosing the defect of the gas vessel by the acoustic emission diagnosis device for the gas vessel using the probabilistic neural network according to the exemplary embodiment of the present disclosure;

FIG. 12 is a graph illustrating the number of hits of acoustic emission signals having amplitude of 50 dB or more during the second detecting process in the method of diagnosing the defect of the gas vessel by the acoustic emission diagnosis device for the gas vessel using the probabilistic neural network according to the exemplary embodiment of the present disclosure;

FIG. 13 is a graph illustrating the number of hits of acoustic emission signals having amplitude of 50 dB or more during the third detecting process in the method of diagnosing the defect of the gas vessel by the acoustic emission diagnosis device for the gas vessel using the probabilistic neural network according to the exemplary embodiment of the present disclosure;

FIG. 14 is a graph illustrating mean count of the acoustic emission signals detected during the first detecting process in the method of diagnosing the defect of the gas vessel by the acoustic emission diagnosis device for the gas vessel using the probabilistic neural network according to the exemplary embodiment of the present disclosure;

FIG. 15 is a graph illustrating mean count of the acoustic emission signals detected during the second detecting process in the method of diagnosing the defect of the gas vessel by the acoustic emission diagnosis device for the gas vessel using the probabilistic neural network according to the exemplary embodiment of the present disclosure;

FIG. 16 is a graph illustrating mean count of the acoustic emission signals detected during the third detecting process in the method of diagnosing the defect of the gas vessel by the acoustic emission diagnosis device for the gas vessel using the probabilistic neural network according to the exemplary embodiment of the present disclosure;

FIG. 17 is a graph illustrating mean duration of the acoustic emission signals detected during the first detecting process in the method of diagnosing the defect of the gas vessel by the acoustic emission diagnosis device for the gas vessel using the probabilistic neural network according to the exemplary embodiment of the present disclosure;

FIG. 18 is a graph illustrating mean duration of the acoustic emission signals detected during the second detecting process in the method of diagnosing the defect of the gas vessel by the acoustic emission diagnosis device for the gas vessel using the probabilistic neural network according to the exemplary embodiment of the present disclosure;

FIG. 19 is a graph illustrating mean duration of the acoustic emission signals detected during the third detecting process in the method of diagnosing the defect of the gas vessel by the acoustic emission diagnosis device for the gas vessel using the probabilistic neural network according to the exemplary embodiment of the present disclosure;

FIG. 20 is a graph illustrating mean energy during the third detecting process in the method of diagnosing the defect of the gas vessel by the acoustic emission diagnosis device for the gas vessel using the probabilistic neural network according to the exemplary embodiment of the present disclosure; and

FIG. 21 a table illustrating measured values of the features extracted in the extracting step in the method of diagnosing the defect of the gas vessel by the acoustic emission diagnosis device for the gas vessel using the probabilistic neural network according to the exemplary embodiment of the present disclosure.

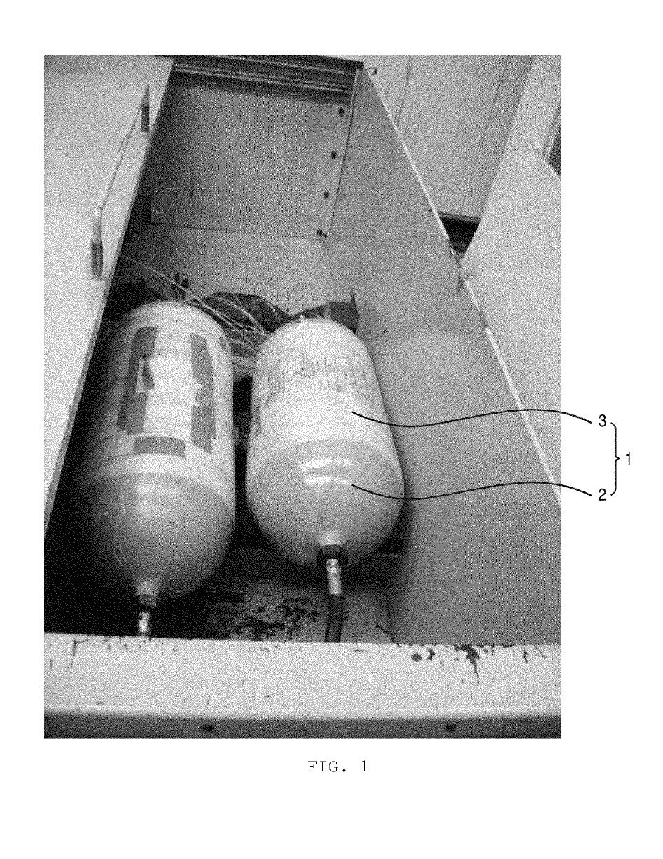

### DETAILED DESCRIPTION

Exemplary embodiments of the present disclosure will now be described in detail with reference to the accompanying drawings. It is to be understood that such embodiments are merely exemplary that various and alternative forms may be employed. Therefore, specific structural and functional details disclosed herein are not to be interpreted as limiting, but merely as representative bases for teaching one skilled in the art.

As set forth above, according to exemplary embodiments, in an acoustic emission diagnosis devices for a gas vessel using a probabilistic neural network and a method of diagnosing a defect of the gas vessel using the same, acoustic emission signal sensors are attached to a plurality of portions of the gas vessel to detect acoustic emission signals, and features in which the detected acoustic emission signals are varied are extracted, so that a damaged degree of the gas vessel can be determined using the probabilistic neural network that has been trained through a classification learning algorithm for the extracted features

Further, the features in which the acoustic emission signals are varied are analyzed when filling the inside of the gas vessel with gas, when holding the pressure after filling, and when decreasing the pressure again.

Accordingly, the gas vessel is inspected immediately after the gas vessel is manufactured, and a defect of the gas vessel attached to a vehicle is diagnosed in operation, so that the convenience for use can be improved and the diagnosing can be performed with more accuracy. As a result, it is possible to manage the gas vessel by grade and to decide subsequent inspection time.

While the present disclosure has been confirmed and described in connection with the exemplary embodiments, it will be apparent to those skilled in the art that modifications and variations can be made without departing from the spirit and scope thereof as defined by the appended claims.

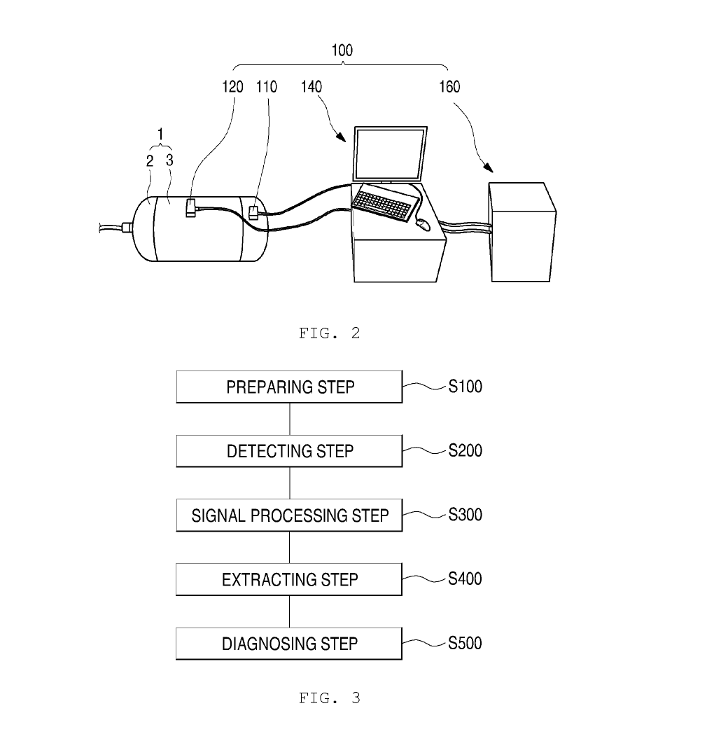

Hereinafter, a configuration of an acoustic emission diagnosis device according to an exemplary embodiment of the present disclosure will be described with reference to FIG. 2.

FIG. 2 is a perspective view illustrating a configuration of an acoustic emission diagnosis device 100 according to the exemplary embodiment of the present disclosure.

As illustrated in FIG. 2, the acoustic emission diagnosis device 100 is configured to diagnose a defect of a gas vessel 1 that includes a metal liner 2 for storing therein gas and a composite material 3 wound at a center of an outer surface of the metal liner 2 to reinforce the metal liner 2.

The acoustic emission diagnosis device includes a first acoustic emission signal sensor 110 attached to one side of the outer surface of the metal liner 2, that is, a bottom part of the metal liner 2 where the composite material 3 is not provided, to detect an acoustic emission signal; a second acoustic emission signal sensor 120 attached to one side of an outer surface of the composite material 3 to detect an acoustic emission signal; a signal processing unit 140 that represents as two or more acoustic emission parameters among the number of hits, amplitude, energy, rise time, count, duration, strength, a signal level, or RMS (Root Mean Square) detected by the first acoustic emission signal sensor 110 and the second acoustic emission signal sensor 120; and an analysis unit 160 that analyzes the acoustic emission parameters to extract features and determines a damaged degree of the gas vessel using a probabilistic neural network that has been trained through a classification learning algorithm for the acoustic parameters.

The acoustic parameters are defined as followings.
event: a parameter indicating that an acoustic emission signal is generated from a generator
hit: a parameter indicating that a cycle of emitting acoustic and one impulsive signal detected by a probe
energy: a parameter corresponding to an area of an event related to magnitude of the generator
signal strength: an absolute value of a amplitude value of the detected acoustic emission signal and a unit in proportion to volt·second
ASL (Average signal level): mean energy obtained by dividing a time integration value of the absolute amplitude value by time
RMS: root mean square of instant value of a voltage being converted
amplitude: maximum amplitude of one acoustic emission event
count: the number of peaks exceeding a set threshold voltage
rise time: a time taken to reach the maximum amplitude after exceeding the threshold voltage in one event
duration: a time taken to end the event after exceeding the threshold voltage in one event

The first acoustic emission signal sensor 110 and the second acoustic emission signal sensor 120 are configured to detect the acoustic emission signals when an internal pressure of the metal liner 2 is changed. The first acoustic emission signal sensor 110 detects the acoustic emission signal from the metal liner 2, and the second acoustic emission signal sensor 120 detects the acoustic emission signal from the composite material 3.

Specifically, the first acoustic emission signal sensor 110 and the second acoustic emission signal sensor 120 are configured to consecutively detect the acoustic emission signals during a period of time to reach a set pressure after the pressure starts to increase by filling the metal liner 2 with a fluid, during a set time to hold the pressure after reaching the set pressure, and during a period of time to decrease the pressure by discharging the fluid from the inside of the metal liner 2 after the set time elapses.

In the exemplary embodiment of the present disclosure, a type II gas vessel having a working pressure of 207 bars may be used as the gas vessel 1, and thus the set pressure may be set to be 207 bars.

Thus, the first acoustic emission signal sensor 110 and the second acoustic emission signal sensor 120 consecutively detect the acoustic emission signals during a period of time to reach the set pressure of 207 bars after the internal pressure of the metal liner 2 starts to increase, during the set time of ten minutes when the internal pressure of the metal liner 2 is set to be 207 bars, and during a period of time to discharge the fluid from the inside of the metal liner 2 to the outside after the set time of ten minutes elapses.

The signal processing unit 140 converts the acoustic emission signals detected by the first acoustic emission signal sensor 110 and the second acoustic emission signal sensor 120 into the acoustic emission parameters, and simultaneously represents a change in the number of the acoustic emission signals the converted acoustic emission parameters. The acoustic emission parameter includes the number of hits, amplitude, rise time, count, duration, and the like. In the exemplary embodiment of the present disclosure, safety of the gas vessel 1 is diagnosed using a combination of at least two or more acoustic emission parameters among the acoustic emission parameters.

Specifically, the features are extracted by the analysis unit 160 from the acoustic emission parameters represented by the signal processing unit 140, and the analysis unit 160 determines the damaged degree of the gas vessel 1 using the extracted features of the acoustic emission parameters.

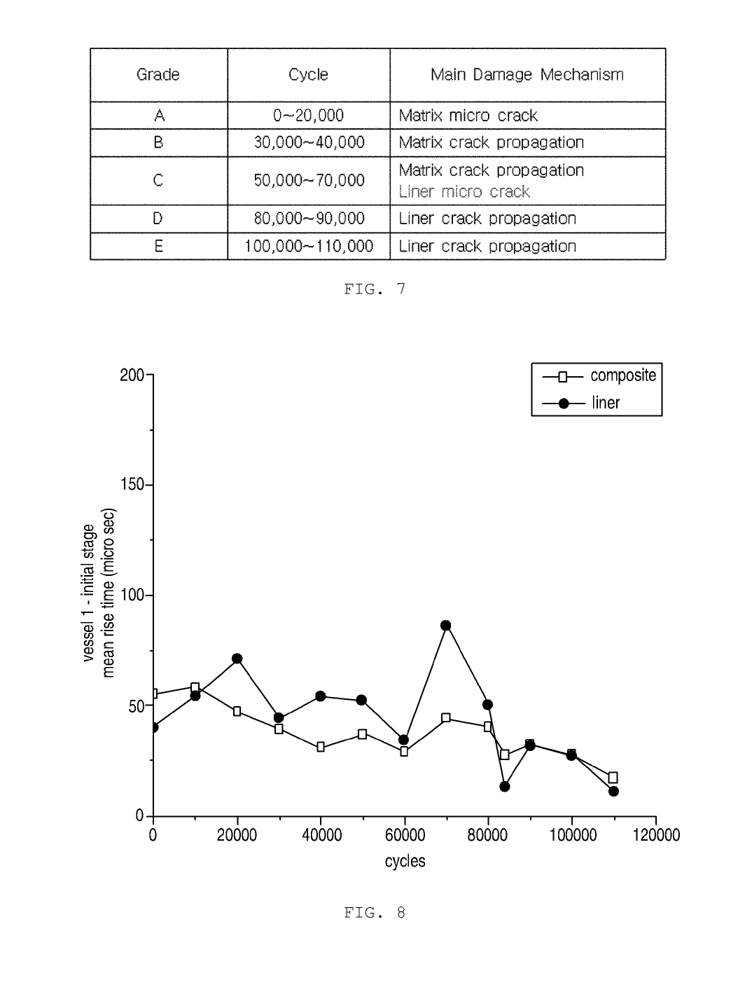

Here, the features may be extracted from the acoustic emission parameters in various ways, as illustrated in FIG. 6, and the analysis unit 160 can determine the damaged degree of the gas vessel when the acoustic emission parameters are provided by adopting the probabilistic neural network that has been trained through the classification learning algorithm for the acoustic emission parameters.

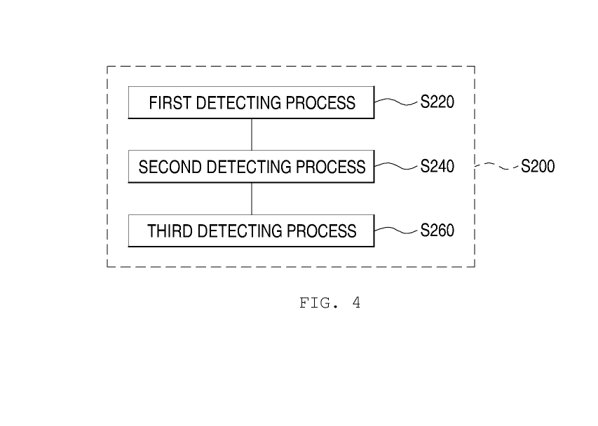

Hereinafter, a method of diagnosing a defect of the gas vessel 1 by the acoustic emission diagnosis device 100 according to the exemplary embodiment of the present disclosure will be described with reference to FIG. 3.

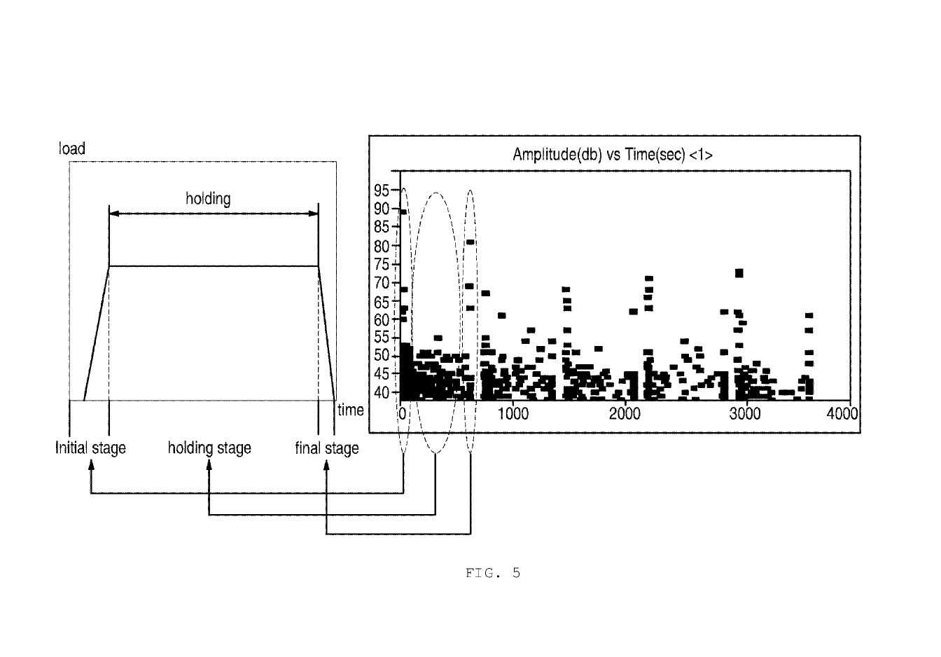

FIG. 3 is a flowchart illustrating a method of diagnosing a defect of the gas vessel 1 by the acoustic emission diagnosis device 100 according to the exemplary embodiment of the present disclosure, and FIG. 4 is a flowchart illustrating detailed processes of a detecting step S200 as one step of the method of diagnosing the defect of the gas vessel 1 by the acoustic emission diagnosis device 100 according to the exemplary embodiment of the present disclosure.

As illustrated in FIGS. 3 and 4, the method of diagnosing the defect of the gas vessel 1 includes a preparing step S100 of attaching the first acoustic emission signal sensor 110 on the one side of the metal liner 2 serving as a component of the gas vessel 1 to detect the acoustic emission signal and attaching the second acoustic emission signal sensor 120 on the one side of the outer surface of the composite material 3 wound at the outer surface of the metal liner 2 to detect the acoustic emission signal; a detecting step S200 of detecting the acoustic emission signals by sequentially increasing, holding and decreasing the internal pressure of the metal liner 2; a signal processing step S300 of representing the acoustic emission signals as two or more acoustic emission parameters among the number of hits, amplitude, rise time, count, duration, and the like using the signal processing unit 140 serving as a component of the acoustic emission diagnosis device 100; an extracting step S400 of extracting the features from the acoustic emission parameters; and a diagnosing step S500 of diagnosing the defect of the gas vessel 1 using the probabilistic neural network that has been trained through classification for the acoustic emission parameters.

As illustrated in FIG. 2, the preparing step S100 is a process of preparing to detect the acoustic emission signals by attaching the first acoustic emission signal sensor 110 and the second acoustic emission signal sensor 120 to the outer surfaces of the metal liner 2 and the composite material 3.

After the preparing step S100, the detecting step S200 is performed. The detecting step S200 is a process of detecting acoustic signals emitted while increasing the pressure by injecting the fluid into the metal liner 2. The first acoustic emission signal sensor 110 detects the acoustic signal propagated through the metal liner 2, and the second acoustic emission signal sensor 120 detects the acoustic signal propagated through the composite material 3.

Since the detecting is performed during a period of time to increase the internal pressure of the metal liner 2 to the set pressure and during the set time after reaching the set pressure, and the detecting step S200 includes a plurality of processes.

Specifically, as illustrated in FIG. 4, the detecting step S200 includes a first detecting process S220 of detecting the acoustic emission signals during a period of time to reach the set pressure after the internal pressure of the metal liner starts to increase; a second detecting process S240 of detecting the acoustic emission signals during the set time after reaching the set pressure; and a third detecting process S260 of detecting the acoustic emission signals during a period of time to decrease the internal pressure of the metal liner 2 after the set time elapses.

The first detecting process S220, the second detecting process S240, and the third detecting process S260 are consecutively performed. The first acoustic emission signal sensor 110 and the second acoustic emission signal sensor 120 consecutively operate to detect the acoustic emission signals.

In the detecting step S200, the set pressure is set to be 207 bars, and the set time is set to be ten minutes in the exemplary embodiment of the present disclosure.

After the detecting step S200, the signal processing step S300 is performed. The signal processing step S300 is a process of converting the acoustic emission signals detected by the first acoustic emission signal sensor 110 and the second acoustic emission signal sensor 120 into the acoustic emission parameters and simultaneously representing a change in the number of the acoustic emission signals as the acoustic emission parameters. In the signal processing step, the acoustic emission signals detected by the first acoustic emission signal sensor 110 and the second acoustic emission signal sensor 120 during the first detecting process S220 to the third detecting process S260 are analyzed using parameter values such as the number of hits, amplitude, rise time, count, and duration, or mean values.

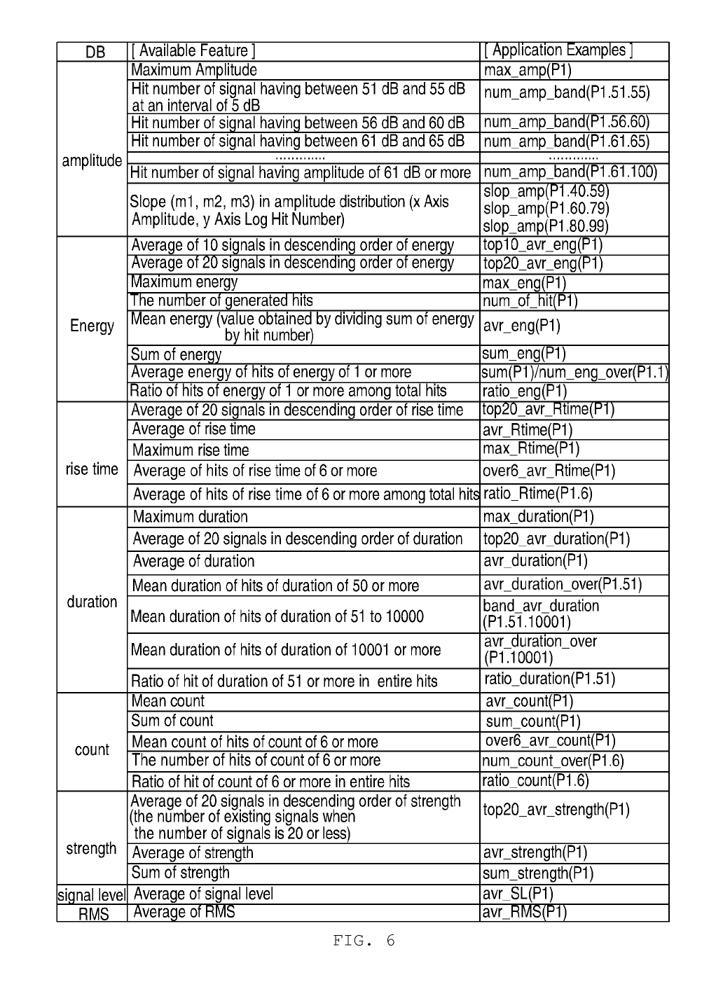

Hereinafter, amplitude in the first detecting process S220 to the third detecting process S260 will be described with reference to FIG. 5.

FIG. 5 is a graph illustrating zones for detecting the acoustic emission signals in the detecting step S200 as one step of the method of diagnosing the defect of the gas vessel 1 by the acoustic emission diagnosis device 100 according to the exemplary embodiment of the present disclosure.

As illustrated in FIG. 5, the detected acoustic emission signals are measured from a point of time where the pressure starts to change. The acoustic emission signals are measured during the set time (ten minutes) after reaching the set pressure, and are then measured while decreasing the pressure by discharging the fluid from the inside of the metal liner 2 after the set time elapses.

An increase in a fatigue cycle means that an increase in the damage of the gas vessel 1 such as an increase in the crack of the composite material 3 and an increase in the fatigue crack of the metal liner 2. As the fatigue cycle increases, the damage of the gas vessel becomes worse, and a leak or a burst occurs in the gas vessel, resulting in an accident.

However, as illustrated in FIG. 5, these parameters may not tend to merely increase or merely decrease depending on a change in the fatigue cycle. Accordingly, it is difficult to accurately determine the damaged degree and the lifespan by only using one parameter.

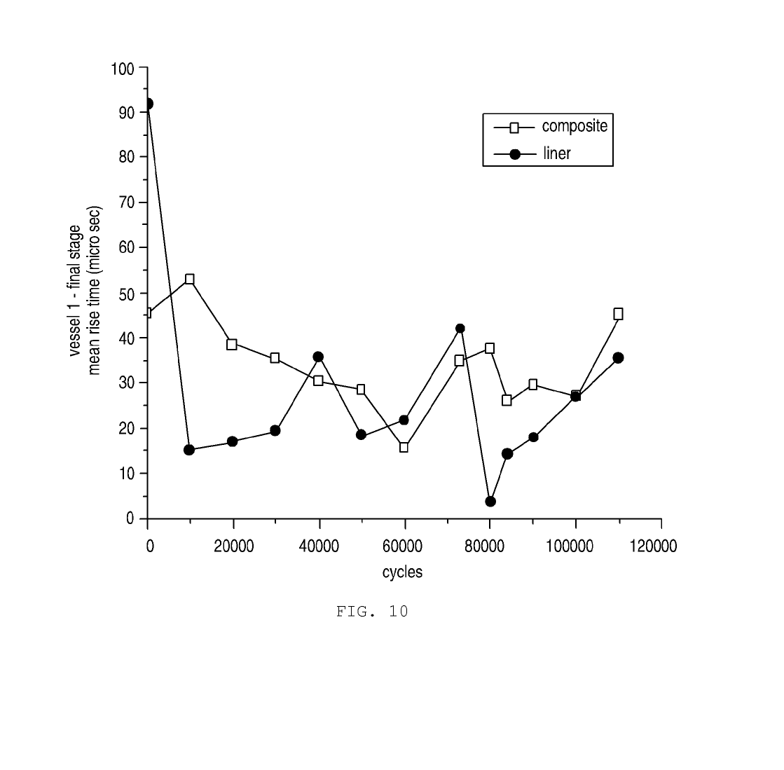

Various parameter values or mean values are presented, as illustrated in FIGS. 8 to 10.

FIGS. 8 to 10 are graphs illustrating mean rise time during the first detecting process S220, the second detecting process S240, and the third detecting process S260 in the method of diagnosing the defect of the gas vessel 1 by the acoustic emission diagnosis device 100 according to the exemplary embodiment of the present disclosure. A mark “” depicts mean rise time of the signal detected by the first acoustic emission signal sensor 110, and a mark “▪” depicts mean rise time of the signal detected by the second acoustic emission signal sensor 120.

As illustrated in FIG. 8, the signal obtained from the composite material 3 by the second acoustic emission signal sensor 120 in the first detecting process S220 exhibits a tendency that the mean rise time is decreased before 40,000 cycles, but is not greatly changed before 80,000 cycles after 40,000 cycles and is then decreased after 80,000 cycles.

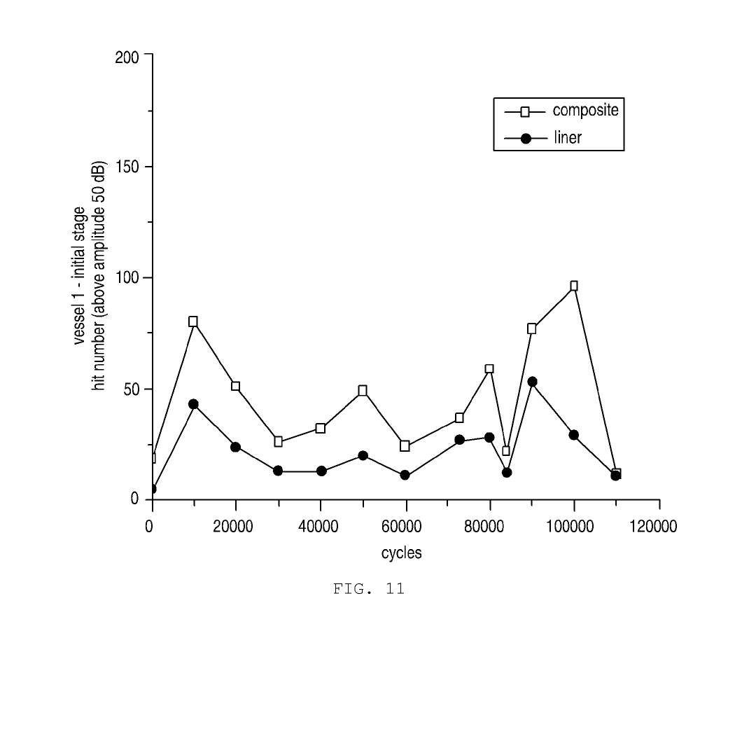

As illustrated in FIG. 9, the signal obtained from the composite material 3 by the second acoustic emission signal sensor 120 in the second detecting process S240 exhibits a tendency that the mean rise time is decreased before 70,000 cycles, but is slightly increased before 90,000 cycles after 70,000 cycles and is then decreased after 90,000 cycles.

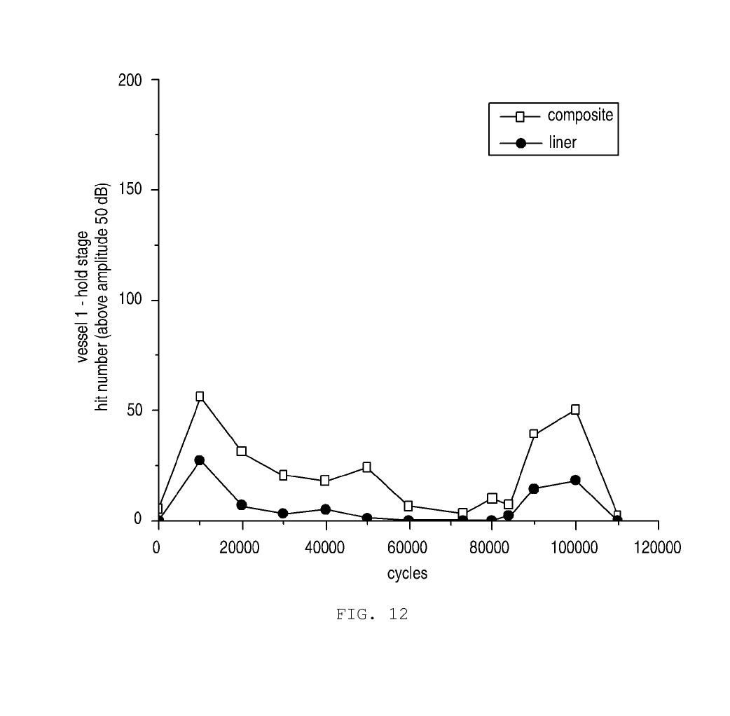

As illustrated in FIG. 10, the signal obtained from the composite material 3 by the second acoustic emission signal sensor 120 in the third detecting process S260 exhibits a tendency that the mean rise time is decreased before 60,000 cycles, but is slightly increased before 80,000 cycles after 60,000 cycles and is then decreased after 80,000 cycles.

As illustrated in FIG. 8, the signal obtained from the metal liner 2 by the first acoustic emission signal sensor 110 exhibits a tendency that the mean rise time thereof is sharply decreased when injecting the fluid, but is increased before 40,000 cycles.

The signal exhibits a tendency that the mean rise time thereof is repeatedly decreased and increased after 40,000 cycles.

Accordingly, it can be seen that the mean rise time of the acoustic emission signal obtained from the metal liner 2 by the first acoustic emission signal sensor 110 is greater than that of the signal obtained from the composite material 3. Further, it can be seen that the mean rise time does not have a strong influence on the fatigue cycle.

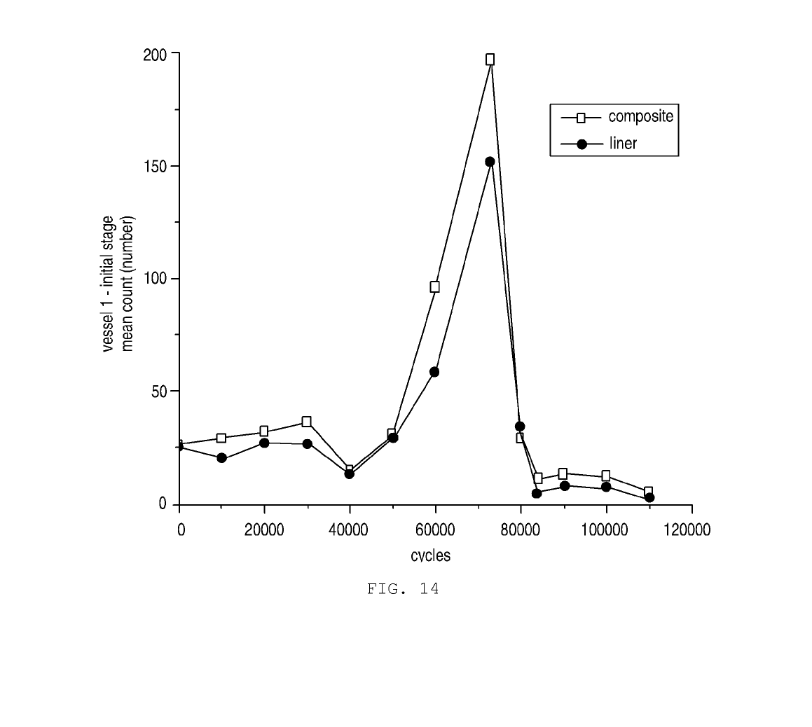

FIGS. 11 to 13 are graphs illustrating the number of hits of the acoustic emission signals having amplitude of 50 dB or more during the first detecting process S220 to the third detecting process S260 in the method of diagnosing the defect of the gas vessel 1 by the acoustic emission diagnosis device 100 according to the exemplary embodiment of the present disclosure.

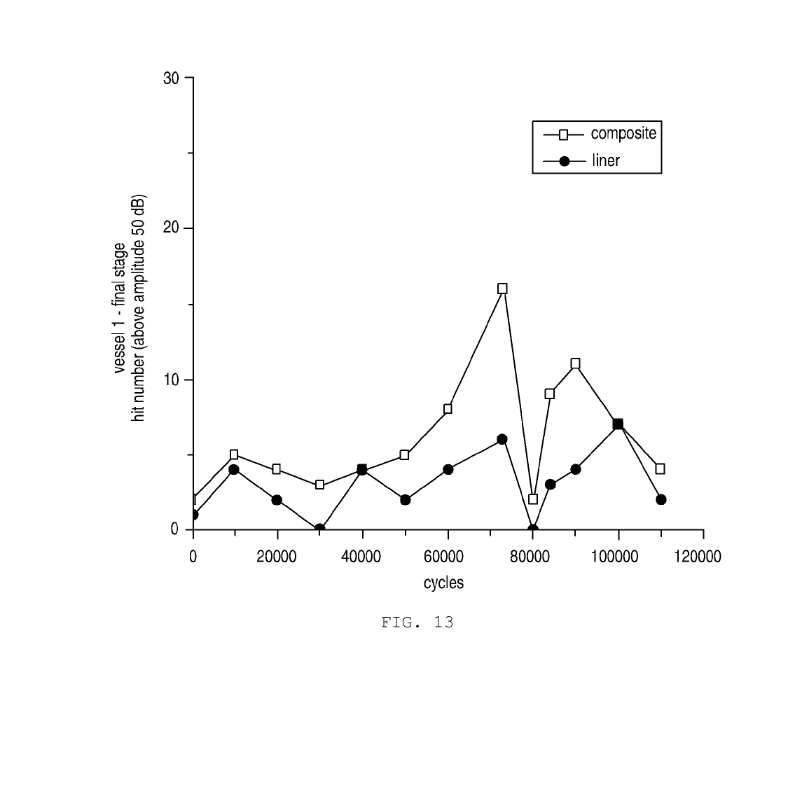

As can be seen from the number of hits of the acoustic emission signals having amplitude of 50 dB or more obtained in the first detecting process S220 as illustrated in FIG. 11 and the number of hits of the acoustic emission signals having amplitude of 50 dB or more obtained in the second detecting process S240 as illustrated in FIG. 12, with regard to the influence of the amplitude on the fatigue cycle, there is a feature that the signals having amplitude of 50 dB or more are hardly detected between 60,000 cycles and 80,000 cycles during the pressure holding period.

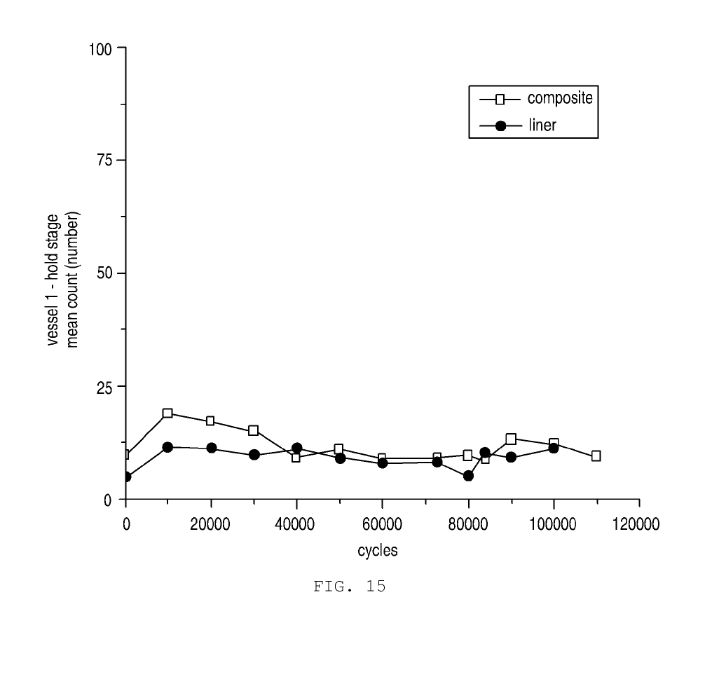

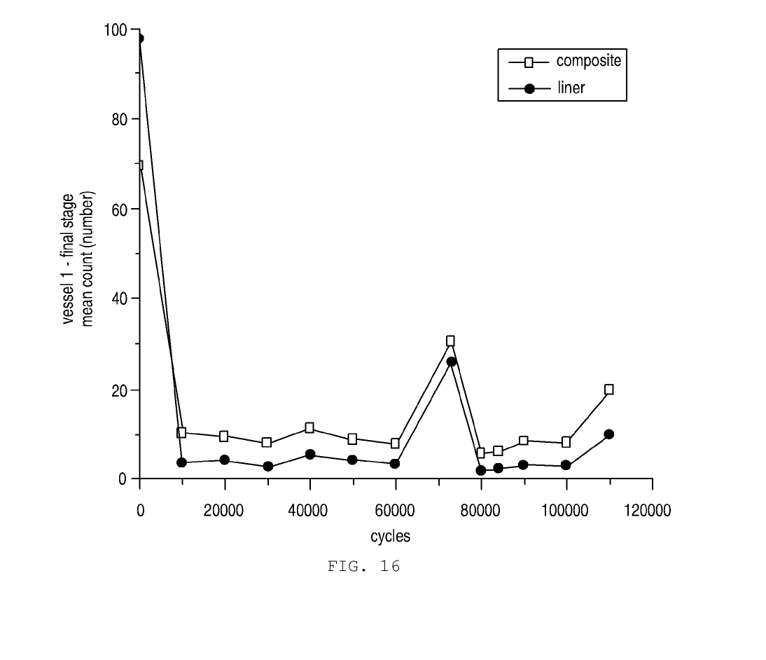

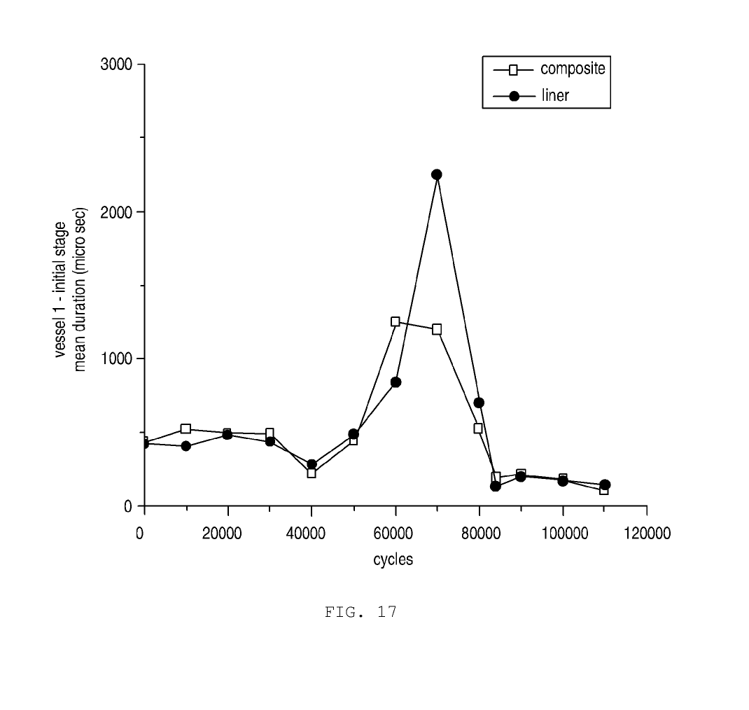

FIGS. 14 to 16 are graphs illustrating mean count of the acoustic emission signals detected during the first detecting process S220 to the third detecting process S260 in the method of diagnosing the defect of the gas vessel 1 by the acoustic emission diagnosis device 100 according to the exemplary embodiment of the present disclosure.

As illustrated in FIGS. 14 to 16, in the first detecting process S220, a change of the mean count to the fatigue cycle exhibits a tendency that the mean count is maintained at 25 to 30 before 30,000 cycles and is then decreased to about 10 at 40,000 cycles, but is greatly increased between 60,000 cycles and 70,000 cycles and is then decreased to 10 or less after 80,000 cycles.

Meanwhile, in the second detecting process S240, the mean count is maintained at about 10 regardless of the fatigue cycle.

In the third detecting process S260, a change of the mean count to the fatigue cycle exhibits a tendency that the mean count in the first acoustic emission signal sensor 110 is constantly maintained at about 4 to 6 and the mean count in the second acoustic emission signal sensor 120 is constantly maintained at about 9 to 11. Then, the mean count is sharply increased between 60,000 cycles and 70,000 cycles, but is sharply decreased before 80,000 cycles after 70,000 cycles and is then constantly maintained after 80,000 cycles.

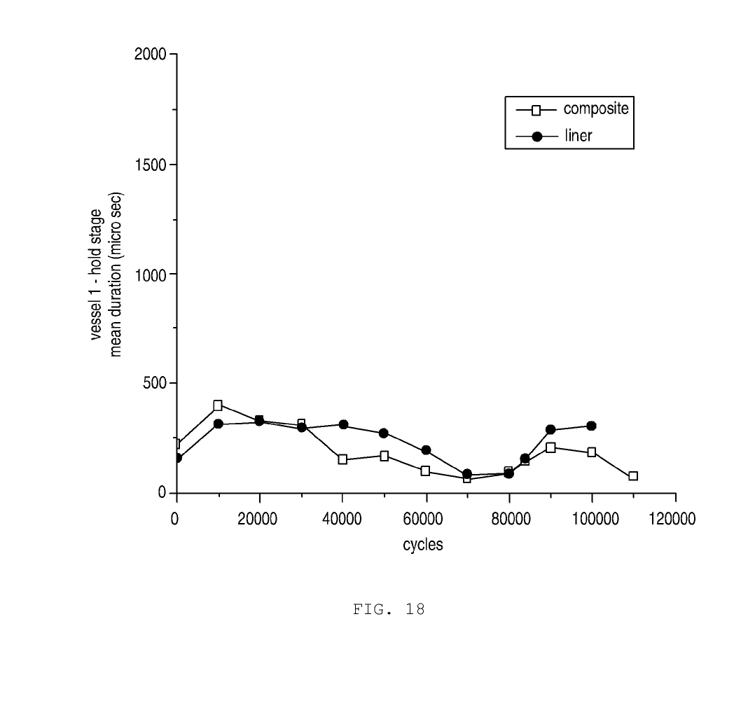

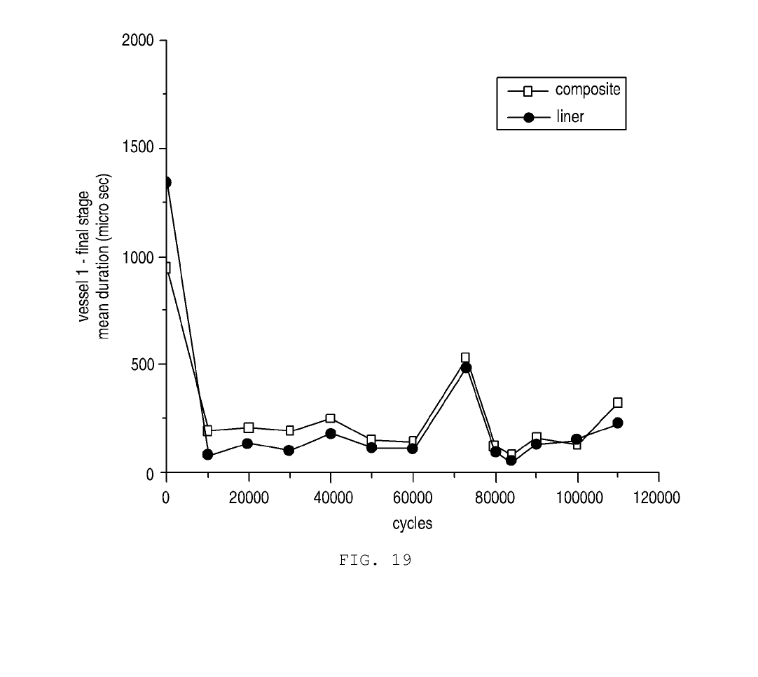

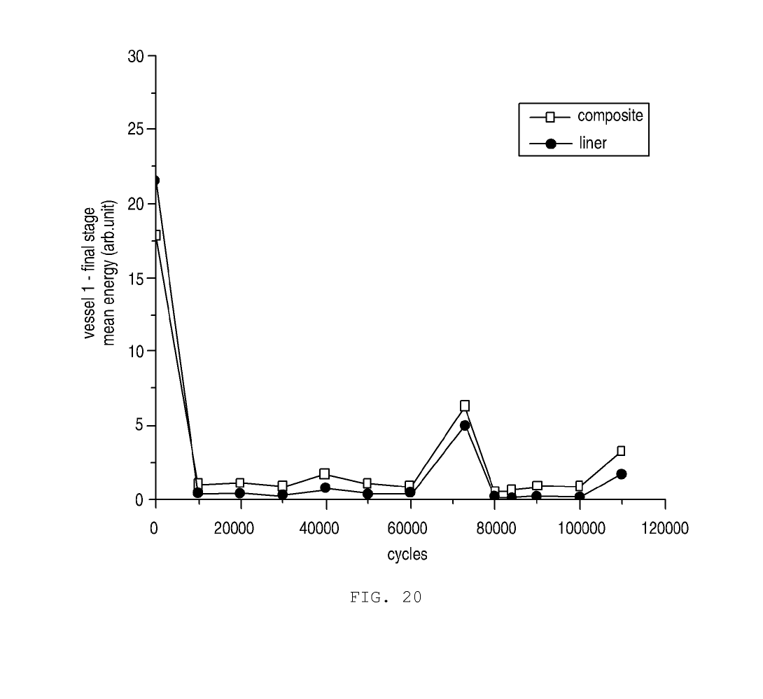

FIGS. 17 to 19 are graphs illustrating mean duration of the acoustic emission signals detected during the first detecting process S220 to the third detecting process S260 in the method of diagnosing the defect of the gas vessel 1 by the acoustic emission diagnosis device 100 according to the exemplary embodiment of the present disclosure.

As illustrated in FIGS. 17 to 19, in the first detecting process S220, a change of the mean duration to the fatigue cycle exhibits a tendency that the mean duration is maintained at about 500 before 50,000 cycles, but is increased to 1,000 or more between 60,000 cycles and 70,000 cycles and is then decreased to 200 or less after 80,000 cycles.

In the second detecting process S240, a change of the mean duration to the fatigue cycle for the signal detected from the composite material 3 exhibits a tendency that the mean duration is decreased before 70,000 cycles, but is slightly increased after 70,000 cycles and is then decreased.

In the third detecting process S260, a change of the mean duration to the fatigue cycle exhibits a tendency that the mean duration is constantly maintained at about 200 before 60,000 cycles, but is increased to 500 or more between 60,000 cycles and 70,000 cycles and is then decreased to 200 or less after 80,000 cycles.

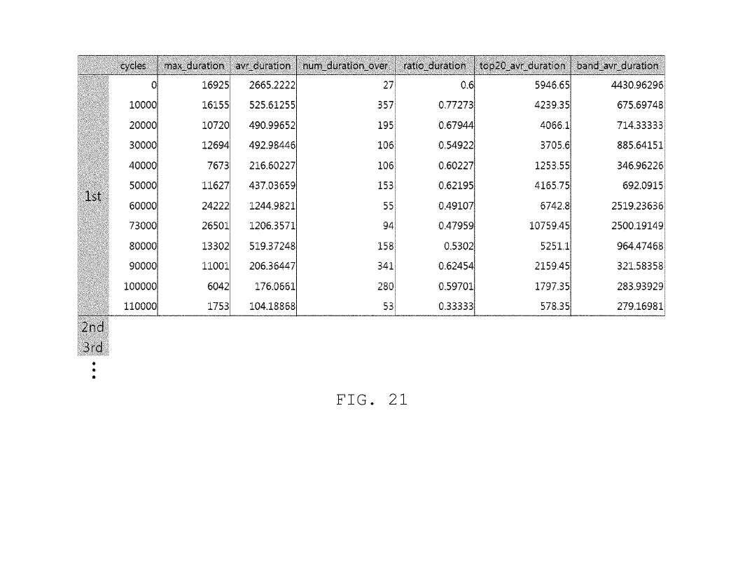

FIG. 20 is a graph illustrating mean energy in the third detecting process in the method of diagnosing the defect of the gas vessel by the acoustic emission diagnosis device according to the exemplary embodiment of the present disclosure. As illustrated in FIG. 20, a change of the mean energy to the fatigue cycle exhibits a tendency that the mean energy is maintained at 2 or less before 60,000 cycles and is then increased to 5 or more between 60,000 cycles and 75,000 cycles, but is sharply decreased between 75,000 cycles and 80,000 cycles and is then maintained at 2 or less after 80,000 cycles.

Hereinafter, the extracting step S400 of extracting the features based on data of the signal processing step S300 will be described.

FIG. 21 is a table illustrating measured values of the features extracted in the extracting step in the method of diagnosing the defect of the gas vessel by the acoustic emission diagnosis device for the gas vessel using the probabilistic neural network according to the exemplary embodiment of the present disclosure. The features such as max duration, average duration, and ratio duration can be extracted for the duration as the acoustic emission parameter.

The extracted features may be used to evaluate the safety of the gas vessel 1 in the diagnosing step S500.

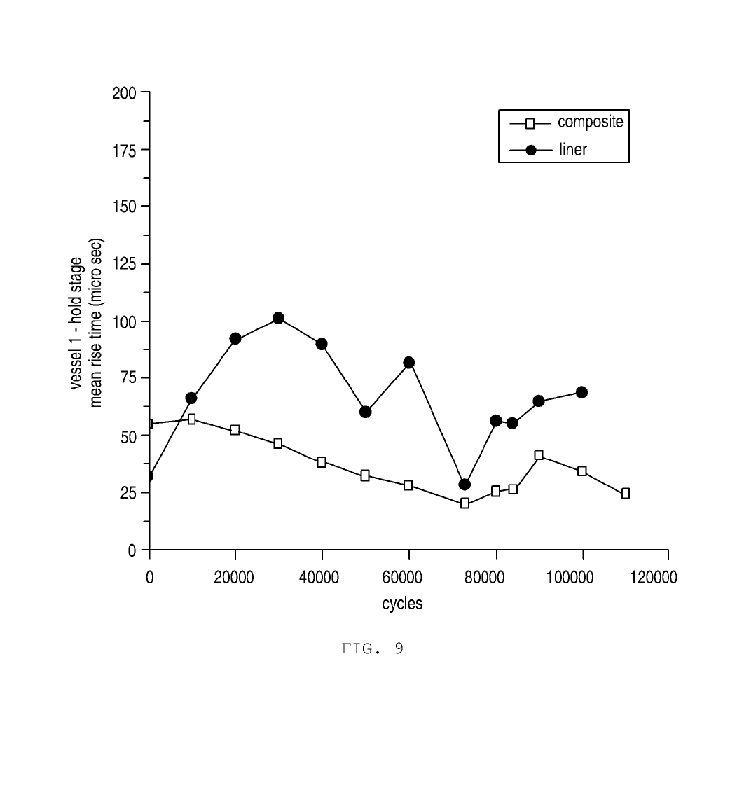

As illustrated in FIG. 7, in the diagnosing step S500, the acoustic emission cycles are graded from “A” to “E”, and the diagnosed result for each grade is briefly presented.

The diagnosed result for each grade is decided based on data previously stored in the analysis unit 160 that has been trained through the classification learning algorithm for the acoustic emission parameters. Such a diagnosed result may be changed by adding a plurality of classification learning algorithms, and thus the diagnosing can be further accurately performed.

For example, the diagnosed result may be previously stored in the analysis unit 160 based on the following experimental results.

When a vehicle in operation is periodically inspected or when the vehicle needs to be inspected immediately after an accident, acoustic emission signals are obtained during a period of time to supply with gas fuel and during ten minutes for holding the pressure after supplying with gas fuel, and a damaged degree is determined by comparing the data with a combination of the parameters described above, so that the lifespan can be predicted.

(1) For example, when the mean rise time of the signal obtained by the second acoustic emission signal sensor 120 attached to the composite material 3 during the first detecting process S220 is about 30, it is predicted from the ▪ marked graph of FIG. 8 that the vehicle has a lifespan corresponding to a cumulative fatigue cycle of about 40,000 cycles to 80,000 cycles.

(2) When the mean rise time of the signal obtained by the first acoustic emission signal sensor 110 attached to the metal liner 2 during the first detecting process S220 is about 40, it is predicted from the marked graph of FIG. 8 that the vehicle has a lifespan corresponding to a cumulative fatigue cycle of about 30,000 cycles to 60,000 cycles.

(3) Accordingly, it can be predicted from a combination of (1) and (2) that the vehicle has a lifespan corresponding to a cumulative fatigue cycle of about 40,000 cycles to 60,000 cycles.

(4) Meanwhile, when the mean rise time of the signal obtained by the second acoustic emission signal sensor 120 attached to the composite material 3 during the second detecting process S240 is about 25, it is predicted from the a black-line graph of FIG. 9 that the vehicle has a lifespan corresponding to a cumulative fatigue cycle of about 50,000 cycles to 80,000 cycles.

(5) It can be predicted from a combination of (3) and (4) that the vehicle has a lifespan corresponding to a cumulative fatigue cycle of about 50,000 cycles to 60,000 cycles.

Further, by repeating procedures (1) to (5) for other acoustic emission parameters, the lifespan can be further accurately predicted.

While exemplary embodiments are described above, those embodiments do not describe all embodiments possible and the scope of the present disclosure is not limited to those exemplary embodiments. The embodiments and words used herein are therefore descriptive rather than limiting, and it is to be appreciated that those skilled in the art can change or modify the exemplary embodiments described without departing from the scope and spirit of the present disclosure.

What is claimed is:

1. An acoustic emission diagnosis device for a gas vessel using a probabilistic neural network, the device diagnosing a defect of the gas vessel including a metal liner and a composite material wound at a part of an outer surface of the metal liner to reinforce the metal liner, the device comprising:
a second acoustic emission signal sensor that is attached to a center of an outer surface of the composite material to detect an acoustic emission signal;
a first acoustic emission signal sensor that is attached to a bottom part of the outer surface of the metal liner at which the composite material is not provided to detect an acoustic emission signal;
a signal processing unit that represents the acoustic emission signals detected by the first acoustic emission signal sensor and the second acoustic emission signal sensor as two or more acoustic emission parameters among the number of hits, amplitude, energy, rise time, count, duration, strength, a signal level, and RMS (Root Mean Square); and
a diagnosis unit that extracts features by analyzing the acoustic emission parameters and determines a damaged degree of the gas vessel using the probabilistic neural network that has been trained through a classification learning algorithm for the acoustic emission parameters.

2. The acoustic emission diagnosis device for the gas vessel using the probabilistic neural network according to claim 1, wherein the first acoustic emission signal sensor and the second acoustic emission signal sensor consecutively detect the acoustic emission signals during a period of time to increase an internal pressure of the metal liner to a set pressure, during the set pressure, and during a period of time to decrease the internal pressure to a level less than the set pressure.

3. The acoustic emission diagnosis device for the gas vessel using the probabilistic neural network according to claim 2, wherein the signal processing unit converts the acoustic emission signals detected by the first acoustic emission signal sensor and the second acoustic emission signal sensor into the acoustic emission parameters, and simultaneously represents a change in the number of the acoustic emission signals as the converted acoustic emission parameters.

4. The acoustic emission diagnosis device for the gas vessel using the probabilistic neural network according to claim 3, wherein the set pressure corresponds to a working pressure of the gas vessel, and the first acoustic emission signal sensor and the second acoustic emission signal sensor detect the acoustic emission signals during a predetermined set time.

5. A method of diagnosing a defect of a gas vessel by an acoustic emission diagnosis device for the gas vessel using a probabilistic neural network, the gas vessel including a metal liner and a composite material wound at apart of an outer surface of the metal liner to reinforce the metal liner, the method comprising:
attaching a second acoustic emission signal sensor to a center of an outer surface of the composite material to detect an acoustic emission signal and attaching a first acoustic emission signal sensor to a bottom part of the outer surface of the metal liner at which the composite material is not provided to detect an acoustic emission signal;
detecting the acoustic emission signals by sequentially increasing, holding, and decreasing an internal pressure of the metal liner;
representing the acoustic emission signals as two or more acoustic emission parameters among the number of hits, amplitude, energy, rise time, count, duration, strength, a signal level, and RMS (Root Mean Square) by a signal processing unit serving as a component of the acoustic emission diagnosis device for the gas vessel;
extracting features from the acoustic emission parameters; and
diagnosing the defect of the gas vessel using the probabilistic neural network that has been trained through a classification learning algorithm for the acoustic emission parameters.

6. The method of diagnosing the defect of the gas vessel by the acoustic emission diagnosis device for the gas vessel using the probabilistic neural network according to claim 5, wherein the detecting the acoustic emission signals includes:
a first detecting process of detecting during a period of time to reach a set pressure after the internal pressure of the metal liner starts to increase;
a second detecting process of detecting during a set time after reaching the set pressure; and
a third detecting process of detecting during a period of time to reduce the internal pressure of the metal liner after the set time elapses.

7. The method of diagnosing the defect of the gas vessel by the acoustic emission diagnosis device for the gas vessel using the probabilistic neural network according to claim 6, wherein, in the representing the acoustic emission signals, the acoustic emission signals detected by the first acoustic emission signal sensor and the second acoustic emission signal sensor are converted into the acoustic emission parameters, and a change in the number of the acoustic emission signals are simultaneously represented as the converted acoustic emission parameters.

8. The method of diagnosing the defect of the gas vessel by the acoustic emission diagnosis device for the gas vessel using the probabilistic neural network according to claim 7, wherein, in the detecting the acoustic emission signals, the set pressure corresponds to a working pressure of the gas vessel, and the set time is set to be ten minutes.

9. The method of diagnosing the defect of the gas vessel by the acoustic emission diagnosis device for the gas vessel using the probabilistic neural network according to claim 8, wherein, the first acoustic emission signal sensor and the second acoustic emission signal sensor consecutively operate during the first detecting process, the second detecting process and the third detecting process.
